(19) United States
(12) Patent Application Publication
(10) Pub. No.: US 2021/0268711 A1
(43) Pub. Date: Sep. 2, 2021

(54) Multilayer-Structured Polylactic Acid Resin Foam Sheet Manufactured By Co-Extrusion Foaming Method, Molded Article, Method For Manufacturing Same, And Apparatus For Manufacturing Same

(71) Applicants: Hyo Shik KIM, Gyeonggi-do (KR); Eung Kee LEE, Seoul (KR)

(72) Inventor: Eung Kee LEE, Seoul (KR)

(73) Assignees: Hyo Shik KIM, Gyeonggi-do (KR); Eung Kee LEE, Seoul (KR)

(21) Appl. No.: 17/320,429

(22) Filed: May 14, 2021

Related U.S. Application Data
(63) Continuation of application No. PCT/KR2019/017010, filed on Dec. 4, 2019.

(30) Foreign Application Priority Data
Dec. 5, 2018 (KR) 10-2018-0155588

(51) Int. Cl. B29C 48/21; B29C 48/00; B29C 48/07; B29C 48/80; B29C 48/49; B32B 27/06; B32B 27/36; B32B 27/18

(52) U.S. Cl. CPC B29C 48/21; B29C 48/0012; B29C 48/07; B29C 48/022; B29C 48/834; B29L 2007/002; B29C 48/49; B32B 27/065; B32B 27/36; B32B 27/18; B32B 2266/0264; B29C 48/0017

(57) ABSTRACT

The present invention relates to a polylactic acid resin foam sheet, a molded article, a method for manufacturing same, and an apparatus for manufacturing same, and more specifically, to a multilayered polylactic acid foam sheet, a heat-resistant molded article, a method for manufacturing same, and an apparatus for manufacturing same, the multilayered polylactic acid foam sheet being characterized by including: a foam layer manufactured by extruding a composition including a polylactic acid, a foaming agent, a chain extender, a nucleating agent, and a crystallization accelerator; and a non-foam layer foamed on one surface or both surfaces of the foam layer and manufactured by extruding a composition including a polylactic acid and a crystallization accelerator, wherein the foam layer and the non-foam layer are manufactured by co-extrusion in a single process.

### CROSS-REFERENCE TO RELATED APPLICATIONS AND PRIORITY

This application is a continuation of PCT/KR2019/017010, filed Dec. 4, 2019, which claims priority to and the benefit of Korean Patent Application No. 10-2018-0155588, filed on Dec. 5, 2018, the disclosures of which are incorporated herein by reference in their entirety.

### FIELD

The present invention relates to a polylactic acid foam sheet, a molded article, a method of manufacturing the same and an apparatus for manufacturing the same, and more particularly, a polylactic acid foam sheet, which includes a foam layer manufactured by extruding a composition including a polylactic acid resin, a foaming agent, a chain extender, a nucleating agent and a crystallization accelerator; and a non-foam layer formed on one or both surfaces of the foam layer, and manufactured by extruding a composition comprising a polylactic acid and a crystallization accelerator, a molded article, a method of manufacturing the same, and an apparatus for manufacturing the same.

### BACKGROUND

The statements in this section merely provide background information related to the present disclosure and may not constitute prior art.

Currently, polystyrene foams are widely used as a plastic food container, but environmental hormones and carcinogens are generated during use and there is great difficulty in treatment after use so that various attempts to replace them are made.

To solve this problem, research to utilize biodegradable resins such as polylactic acid, polybutylene succinate, polycaprolactone, polyethylene succinate and polybutylene terephthalate adipate as a foam, which can be degraded by moisture or microorganisms, is actively being conducted.

Particularly, polylactic acid is the most representative biodegradable resin, and has significantly less CO₂ emissions than a petroleum-based material such as polyvinyl chloride or polystyrene during polymerization, use or disposal, and an eco-friendly characteristic of being biodegraded in the natural environment even during disposal. In addition, polylactic acid has similar raw material costs to those of general-purpose plastics, and thus is known as the most realistic eco-friendly plastic that can replace conventional polystyrene-based various packing materials.

Regarding polylactic acid foams, Korean Patent No. 10-0893840 discloses a mixture of biodegradable polyesters, which include: (A) an aromatic-aliphatic polyester having a melting point of 50 to 170° C., (B) an aliphatic polyester having a molecular weight (Mw) of more than 60,000 and a melting point of 50 to 95° C., a polyamide polyester in which a polyester part is the aliphatic polyester, or a polyester containing less than 5 mol % of an aromatic diacid, (C) a polylactic acid polymer having a molecular weight (Mw) of more than 30,000 (here, the concentration of A is 40 to 70 wr % with respect to (A+B), and the concentration of C is 6 to 30 wt % with respect to (A+B+C)).

However, the foam disclosed in the above document may not be used as a high-temperature food container due to poor heat resistance, poor heat deflection temperature and poor durability, and may be limitedly used for meat packing, fruit packing and fish packing.

In addition, a toxic chain extender used to improve viscosity in the manufacture of a polylactic acid foam has a risk of being eluted into food in a food container and absorbed into the human body.

Accordingly, a polylactic acid foam sheet and molded article which have an excellent heat deflection temperature, excellent thermal resistance, excellent durability, excellent human safety and excellent biodegradability while being able to reduce raw material costs and process costs, a method of manufacturing the same and an apparatus for manufacturing the same are required.

In the manufacture of a polylactic acid foam sheet having the above-described characteristics, there are problems as follows:

A porous plastic product may reduce production costs as a lightweight material, and is widely used in various fields due to excellent characteristics such as insulation, sound insulation, impact resistance, light reflection and absorption.

Particularly, a porous plastic expanding with high magnification, for example, 3-fold or more, is in the spotlight as a high value-added material that can be used in a variety of applications.

Widely commercialized plastic materials for foaming are polystyrene and polyethylene, and used in a variety of applications including impact protection packing materials, disposable food containers, insulation materials, automobile parts and other industrial applications.

A porous plastic product may be manufactured in various forms such as a sheet, a board, a profile and a bead, and applied according to purpose.

Due to various advantages provided by a porous cell structure, research on the technology of imparting porosity by continuously extruding general-purpose plastics or engineering plastic materials is rapidly increasing mainly in industry.

Particularly, recently, with the rapidly increasing demand for energy-saving eco-friendly vehicles, the weight reduction of parts to which a porous plastic is applied is emerging as a very important research and development challenge.

However, despite the increasing demand and development efforts for porous plastics in various industries, the technology of continuously extruding high-quality foam plastic products is very scarce.

Meanwhile, due to the characteristics of the foaming process, it is essential to maximize melt strength through cooling of a melt, and to this end, it is very important to construct an efficient and precise extruder barrel cooling system.

However, research and technical solutions related to this are still in the basic stage, which is because, since polystyrene foam widely prepared over a long period of time has a very wide window for a foaming process and can be very easily foamed, the necessity of development of extrusion facility technology was not greatly required.

Particularly, in the case of a semi-crystalline polymer such as polypropylene, polyethylene terephthalate, polyamide or polylactic acid, a foam process window is very narrow because of a crystallization behavior such that there is a technical limit with a conventional foam extruder in order to continuously extrude excellent foam products.

In addition, even in a continuous extrusion foaming process for an amorphous polymer, there is a technical limit of uniformly cooling a melt temperature to obtain a small and uniform cell structure.

In this regard, foam extruders are disclosed in Korean Unexamined Patent Application No. 10-2001-0067785, Korean Patent No. 10-0453808 and Korean Patent No. 10-0699202.

However, when the extruders disclosed in these documents are used, crystallization or solidification caused by overcooling of a melt may occur in a cooling step, the melting strength of the melt may not be maximized since the temperature of the melt may not be uniformly maintained, and the cell structure of a foam becomes non-uniform, and thus a foam with a high foaming rate may not be obtained.

Accordingly, it is necessary to develop an apparatus for manufacturing a polylactic acid foam sheet using a foam extruder, which may maximize the melt strength of a melt by uniformly maintaining the temperature of the melt without crystallization or solidification caused by overcooling of a melt, make a cell structure of a foam uniform and improve a foaming rate.

### SUMMARY

This section provides a general summary of the disclosure and is not a comprehensive disclosure of its full scope or all of its features.

The present invention is directed to providing a polylactic acid foam sheet and a molded article, which may exhibit an excellent heat deflection temperature, excellent heat resistance, excellent durability, excellent human safety and excellent biodegradability by co-extrusion of a foam layer and a thin non-foam layer while being able to reduce raw material costs and process costs.

In addition, the present invention is directed to providing a polylactic acid foam sheet, which may be widely used in a high-temperature food container, a microwave heating container, a low-temperature food container and an industrial packing material due to an excellent heat deflection temperature, excellent thermal resistance, excellent durability and excellent biodegradability, and a method of manufacturing a molded article.

In addition, the present invention is directed to providing an apparatus for manufacturing a polylactic acid foam sheet including a foam extruder, which may maximize the melt strength of a melt by uniformly maintaining the temperature of the melt without crystallization or solidification caused by overcooling of a melt, make a cell structure of a foam uniform and improve a foaming rate.

In addition, the present invention is directed to providing an apparatus for manufacturing a polylactic acid foam sheet including a foam extruder, which may produce a high-quality foam at a high discharge speed by using a combined barrel cooling system in which a water cooler and an oil cooler are connected.

Moreover, the present invention is directed to providing a polylactic acid foam food container with excellent human safety, which has a structural characteristic in which a chain extruder does not elute into food due to a non-foam layer present on the inner surface of a food container.

To achieve the above-described purposes, one aspect of the present invention provides a multilayered polylactic acid foam sheet. The multilayered polylactic acid foam sheet includes a foam layer manufactured by extruding a composition comprising a polylactic acid, a foaming agent, a chain extender, a nucleating agent and a crystallization accelerator; and a non-foam layer formed on one or both surfaces of the foam layer and manufactured by extruding a composition comprising a polylactic acid and a crystallization accelerator, and is manufactured by co-extruding the foam layer and the non-foam layer in a single process. Here, the polylactic acid of the foam layer and the non-foam layer is a stereocomplex polylactic acid prepared by polymerization of 0.1 to 5 mol % of D-lactide and 95 to 99.9 mol % of L-lactide, or blending 10 to 60 wt % of poly-D-lactic acid and 40 to 90 wt % of poly-L-lactic acid, the chain extender is a copolymer of glycidyl methacrylate and styrene; or a copolymer of glycidyl acrylate and styrene, and the composition of the foam layer includes 1 to 10 parts by weight of the foaming agent, 0.3 to 1.5 parts by weight of the chain extender, 0.2 to 5 parts by weight of the nucleating agent and 0.3 to 5 parts by weight of the crystallization accelerator with respect to 100 parts by weight of the polylactic acid.

Another aspect of the present invention provides a polylactic acid foam-molded article which is manufactured using a multilayered polylactic acid foam sheet. The polylactic acid foam-molded article is manufactured by removing a foaming agent included in the foam sheet by aging the multilayered polylactic acid foam sheet for 3 to 10 days; softening the aged foam sheet by heating it to 100 to 250° C.; and molding the softened foam sheet using a mold, wherein the temperature of the mold is 50 to 130° C., the time taken to heat the foam sheet in the mold is 3 to 15 seconds, and the foam-molded article has a crystallinity of 10% or more.

Still another aspect of the present invention provides an apparatus for producing a multilayered polylactic acid foam sheet. The apparatus includes a foam extruder for manufacturing a foam layer; a sub-extruder for manufacturing a non-foam layer; and a co-extrusion die which co-extrudes the foam layer manufactured by the foam extruder and the non-foam layer manufactured by the sub-extruder. Here, the foam extruder includes a first extruder in which a composition containing a thermoplastic resin and a foaming agent is added, melts and is kneaded; a second extruder in which the melt kneaded in the first extruder is received and cooled; and a die which discharges the melt cooled in the second extruder to the outside of the extruder and foams it, wherein a cooling system that cools the melt is installed on the surface of a barrel of the second extruder, in which the front end of the cooling system is a water cooler, and the rear end of the cooling system is an oil cooler, the water cooler cools a high-temperature melt to near a target temperature within a short time, and the oil cooler which makes the temperature of the melt cooled to near a target temperature reach the target temperature to prevent the crystallization or solidification caused by overcooling of a melt, maximize the melt strength of the melt by uniformly maintaining the temperature of the melt, make the cell structure of a foam uniform, and improve a foaming rate. The cooling system may lower the target temperature of the melt to a temperature that is able to maximize the melt strength without crystallization or solidification, and the length of the oil cooler is 5 to 85% of the total length of the cooling system.

Yet another aspect of the present invention provides an apparatus for producing a multilayered polylactic acid foam sheet. The apparatus includes a foam extruder for manufacturing a foam layer; a sub-extruder for manufacturing a non-foam layer; and a co-extrusion die which co-extrudes the foam layer manufactured by the foam extruder and the non-foam layer manufactured by the sub-extruder, in which the foam extruder includes a mixer in which a composition containing a thermoplastic resin and a foaming agent is added, melts and is kneaded; a cooling system in which the melt kneaded in the mixer is received and cooled; and a die which discharges and foams the melt cooled in the second extruder to the outside of the extruder; wherein a cooling means which cools the melt is installed on the surface of the cooling system, in which the front end of the cooling system is a water cooler, and the rear end of the cooling system is an oil cooler, the water cooler cools a high-temperature melt to near a target temperature within a short time, and the oil cooler makes the temperature of the melt cooled to near a target temperature reach the target temperature to prevent crystallization or solidification caused by overcooling of the melt, maximize the melt strength of the melt by uniformly maintaining the temperature of the melt, make the cell structure of a foam uniform, and improve a foaming rate. The cooling system may lower the target temperature of the melt up to a temperature that is able to maximize the melt strength without crystallization or solidification, and the length of the oil cooler is 5 to 85% of the total length of the cooling system.

The present invention can provide a polylactic acid foam sheet which exhibits an excellent heat deflection temperature, excellent thermal resistance, excellent durability, excellent human safety and excellent biodegradability by co-extruding a foam layer and a non-foam layer.

The present invention can also provide a polylactic acid foam-molded article which exhibits an excellent heat deflection temperature, excellent thermal resistance, excellent durability and excellent biodegradability and is widely used in a high temperature food container and a low temperature food container.

The present invention can also provide a polylactic acid foam-molded article which can considerably reduce the thickness of a non-foam layer and have very high economic feasibility by using a co-extrusion method.

The present invention can also provide a food container with excellent thermal resistance, durability, biodegradability and human safety, which has a structural characteristic in which a chain extruder does not elute into food due to a non-foam layer present on the inner surface of a food container.

The present invention can also provide an apparatus for manufacturing a polylactic acid foam sheet including a foam extruder, which can maximize the melt strength of a melt by uniformly maintaining the temperature of the melt without crystallization or solidification caused by overcooling of a melt, make the cell structure of a foam uniform and improve a foaming rate.

The present invention can also provide an apparatus for manufacturing a polylactic acid foam sheet including a foam extruder, which can produce a high-quality foam at a high discharge speed by using a combined barrel cooling system in which a water cooler and an oil cooler are connected.

The present invention can also provide a polylactic acid foam sheet which includes a foam with high foaming magnification through a continuous extrusion process using a polylactic acid, which is a plastic material that is difficult to foam with a conventional extruder.

The present invention can also provide a high-quality polylactic acid foam sheet since the above-described combined barrel cooling system can prevent crystallization or solidification of a melt caused by overcooling even in the case of a semi-crystalline polymer having a narrow process window.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an apparatus and method for manufacturing a polylactic acid foam sheet consisting of two layers according to the present disclosure;

FIG. 2 illustrates an apparatus and method for manufacturing a polylactic acid foam sheet consisting of three layers according to the present disclosure;

FIG. 3 illustrates a tandem foam extruder having two single screw extruders connected in series, which is included in an apparatus for manufacturing a polylactic acid foam sheet of the present disclosure;

FIG. 4 illustrates a tandem foam extruder in which a twin-screw extruder and a single-screw extruder are sequentially connected, included in an apparatus for manufacturing a polylactic acid foam sheet of the present disclosure;

FIG. 5 illustrates a foam extruder with a single screw, included in an apparatus for manufacturing a polylactic acid foam sheet of the present disclosure;

FIG. 6 illustrates a foam extruder with a twin screw, included in an apparatus for manufacturing a polylactic acid foam sheet of the present disclosure;

FIG. 7 illustrates a foam extruder with a water cooler installed on the surface of a barrel of a second extruder, included in an apparatus for manufacturing a polylactic acid foam sheet of the present disclosure;

FIG. 8 illustrates a method of manufacturing a polylactic acid molded article according to the present disclosure; and

FIG. 9 illustrates a polylactic acid molded article manufactured by heat-molding a polylactic acid foam sheet of the present invention.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, the present invention will be described in detail with reference to examples. The terms and examples used herein are merely provided to exemplify the present invention in further detail and help in understanding of those of ordinary skill in the art, and the scope of the present invention should not be interpreted as being limited thereto.

Technical terms and scientific terms used herein represent the meanings commonly understood by those of ordinary skill in the art in the technical field to which the present invention belongs unless otherwise defined.

The present invention relates to a polylactic acid foam sheet, which includes a foam layer manufactured by extruding a composition comprising a polylactic acid, a foaming agent, a chain extender, a nucleating agent and a crystallization accelerator; and a non-foam layer formed on one or both surfaces of the foam layer, and manufactured by extruding a composition comprising a polylactic acid and a crystallization accelerator.

The polylactic acid of the foam layer may be manufactured by a known method. For example, the known method is direct dehydration condensation of lactic acid or ring-opening polymerization of lactide, which is a cyclic dimer of lactic acid.

The polymerization may be performed in a solvent, and when needed, performed using a catalyst or an initiator.

The polylactic acid of the foam layer may be a copolymer prepared by copolymerizing poly-D-lactic acid, poly-L-lactic acid, D-lactide and L-lactide.

The polylactic acid of the foam layer may be prepared by polymerizing 0.1 to 5 mol % of D-lactide and 95 to 99.9 mol % of L-lactide, and preferably, 1 to 4 mol % of D-lactide and 96 to 99 mol % of L-lactide. When the contents of the D-lactide and the L-lactide satisfy the numerical ranges, the thermal resistance, durability, biodegradability and foaming property of the manufactured polylactic acid foam sheet are improved.

In addition, the polylactic acid of the foam layer may be a copolymer prepared by copolymerizing components except lactic acid. For example, physical properties such as flexibility, tensile strength, elongation and heat resistance of the polylactic acid foam sheet may be adjusted by adding a compound such as a polyol, a glycol or a polyhydric carboxylic acid as a copolymerization component during polymerization.

The polyol may be ethylene glycol, 2-methylpropanediol, 1,4-butanediol, 1,5-pentanediol, 1,6-hexanediol, 1,7-heptanediol, 1,8-octanediol, glycerin, trimethylolpropane, pentaerythritol, or 1,2,6-hexanetriol.

The glycol may be ethylene glycol, propylene glycol 1,3-propylene glycol, diethylene glycol, or triethylene glycol.

The polyhydric carboxylic acid may be a polyhydric carboxylic acid such as succinic acid, adipic acid, suberic acid, sebacic acid, dimer acid, malic acid, tartaric acid or citric acid, an oxycarboxylic acid and an ester thereof, or an acid anhydride such as succinic anhydride, maleic anhydride, itaconic anhydride, adipic anhydride, phthalic anhydride, trimellitic anhydride, pyromellitic anhydride, a maleic anhydride-ethylene copolymer and a maleic anhydride-acrylonitrile copolymer.

For example, the polylactic acid of the foam layer may be prepared by polymerization of 1 to 4 mol % of D-lactide, 90 to 95 mol % of L-lactide and 2 to 8 mol % of a polyol, or polymerization of 1 to 4 mol % of D-lactide, 90 to 95 mol % of L-lactide, 1 to 5 mol % of a polyol and 1 to 5 mol % of polyhydric carboxylic acid. When the content of a monomer satisfies the above-described numerical range, the thermal resistance, durability, biodegradability and foaming property of the manufactured polylactic acid foam sheet are improved.

In addition, the polylactic acid of the foam layer may be manufactured of a stereocomplex polylactic acid prepared by blending 10 to 60 wt % of poly-D-lactic acid and 40 to 90 wt % of poly-L-lactic acid.

The composition of the foam layer may include 1 to 10 parts by weight of a foaming agent, 0.2 to 2 parts by weight of a chain extender, 0.2 to 5 parts by weight of a nucleating agent and 0.3 to 5 parts by weight of a crystallization accelerator with respect to 100 parts by weight of the polylactic acid.

As the foaming agent, a physical foaming agent or a chemical foaming agent may be used, and as the physical foaming agent, at least one selected from the group consisting of carbon dioxide, an inert gas such as nitrogen, a hydrocarbon gas such as butane or pentane, and a combination thereof may be used.

As the chemical foaming agent, at least one selected from the group consisting of azodicarbonamide, p,p′-oxybisbenzene sulfonylhydrazide, p-toluene sulfonylhydrazide, benzene sulfonylhydarazide and a combination thereof may be used.

The content of the used foaming agent may be 1 to 10 parts by weight with respect to 100 parts by weight of the polylactic acid, and therefore, a foaming magnification of 5 to 25-fold may be obtained.

When the content of the foaming agent is less than 1 part by weight, sufficient foaming magnification may not be achieved, and when the content of the foaming agent is more than 10 parts by weight, the thermal resistance and durability of the foam sheet may be degraded.

The chain extender may increase the molecular weight and melt strength of the polylactic acid to facilitate an extrusion process.

It is difficult for the polylactic acid to obtain a rheological property suitable for low-density extrusion foaming due to a low molecular weight, and there is a problem of a very small window for a foaming extrusion process. Since the polylactic acid resin discharged from an extruder exhibits low viscosity and melt strength, it is very difficult to manufacture a low-density foam with high foaming magnification through an extrusion process.

The chain extender may be interconnected with the polylactic acid to increase the molecular weight and melt strength of the polylactic acid, and therefore, a foaming extrusion process is possible.

A conventional chain extender may have two or more reactive functional groups such as an epoxy group, an anhydride group and an isocyanate group in one molecule, and exhibit toxicity. Particularly, since a non-reacted chain extender has high molecular mobility at a high temperature, and does relatively easily elute, human safety may be problematic since the chain extender can elute from a food container to food.

The present invention uses a glycidyl acrylate-based compound as a chain extruder to solve the above-mentioned problem. Particularly, the glycidyl acrylate-based compound is preferably a glycidyl acrylate copolymer or terpolymer, or a glycidyl methacrylate copolymer or terpolymer. Since the polymer-type chain extender has low molecular mobility due to a large molecular weight, the elution of a non-reacted chain extender may be minimized at a high temperature.

For example, the glycidyl acrylate-based compound may be a copolymer or terpolymer of glycidyl methacrylate or glycidyl acrylate; and a monomer consisting of an alkyl methacrylate, alkyl acrylate and styrene.

In one example, a copolymer of glycidyl methacrylate and styrene; a terpolymer of glycidyl methacrylate, methyl methacrylate and styrene; a copolymer of glycidyl acrylate and styrene; a terpolymer of glycidyl acrylate, methyl acrylate and styrene may be used.

In the case of a copolymer, the content of glycidyl acrylate or glycidyl methacrylate is preferably 30 to 70 wt %, and the content of a monomer consisting of alkyl methacrylate, alkyl acrylate and styrene is preferably 30 to 70 wt %.

In the case of a terpolymer, the content of glycidyl acrylate or glycidyl methacrylate is preferably 30 to 70 wt %, and the content of alkyl methacrylate or alkyl acrylate is preferably 20 to 50 wt %, and the content of styrene is preferably 10 to 40 wt %.

In addition, as a chain extender, a copolymer of glycidyl methacrylate or glycidyl acrylate; and an acrylate group-containing silane coupling agent may be used.

The acrylate group-containing silane coupling agent may be 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyl trimethoxysilane, methacryloxymethyl triethoxysilane, or methacryloxymethyl trimethoxysilane.

Here, the content of glycidyl acrylate or glycidyl methacrylate is preferably 30 to 70 wt %, and the content of the acrylate group-containing silane coupling agent is preferably 30 to 70 wt %.

The content of the chain extender is preferably 0.2 to 2 parts by weight, and more preferably, 0.3 to 1.5 parts by weight with respect to 100 parts by weight of the polylactic acid. When the content of the chain extender is less than 0.2 parts by weight, it is difficult to increase the molecular weight of the polylactic acid, and when the content is more than 2 parts by weight, the processability of the foam sheet is reduced.

The nucleating agent may be talc, calcium carbonate or silica as an additive that facilitates foaming of the foam layer.

The content of the nucleating agent is preferably 0.2 to 5 parts by weight with respect to 100 parts by weight of the polylactic acid, and when the content of the nucleating agent is less than 0.2 parts by weight, sufficient foaming magnification may not be obtained, and when the content of the nucleating agent is more than 5 parts by weight, the thermal resistance and durability of the foam sheet are reduced.

The crystallization accelerator is an additive that improves thermal resistance and durability by increasing the crystallization rate and crystallinity of a foam sheet or molded article during the manufacture of a foam sheet or a heat molding process, and may be stearic acid, hydroxystearic acid or ethylene bis(stearamide).

The content of the crystallization accelerator is preferably 0.3 to 5 parts by weight with respect to 100 parts by weight of the polylactic acid, and when the content of the crystallization accelerator is less than 0.3 parts by weight, sufficient crystallinity may not be achieved, and when the content of the crystallization accelerator is more than 5 parts by weight, the processability of the foam sheet is reduced.

In addition, the foam layer may further include a silane coupling agent. The silane coupling agent may have an organic functional group capable of bonding with an organic compound and a hydrolyzing group capable of reacting with an inorganic material, and may improve an adhesive strength between polylactic acids, and an adhesive strength between the foam layer and the non-foam layer, thereby increasing the adhesion, thermal resistance and durability of the foam sheet.

As the silane coupling agent, an alkyl group-containing silane coupling agent, an amino group-containing silane coupling agent, an epoxy group-containing silane coupling agent, an acrylate group-containing silane coupling agent, an isocyanate group-containing silane coupling agent, a mercapto group-containing silane coupling agent, a fluorine group-containing silane coupling agent, or a vinyl group-containing silane coupling agent is used.

The content of the silane coupling agent is preferably 1 to 10 parts by weight with respect to 100 parts by weight of the polylactic acid, when the content is less than 1 part by weight, it is difficult to expect an improvement in adhesion, and when the content is more than 10 parts by weight, the interfacial adhesion property and thermal resistance are rather lowered due to the excessive use of the silane coupling agent.

Particularly, both of the epoxy group-containing silane coupling agent and the acrylate group-containing silane coupling agent are used.

The foam layer is manufactured in a sheet shape by continuously extruding a composition containing polylactic acid, and the thickness of the foam layer is preferably 1 to 10 mm.

The non-foam layer is present on one or both surfaces of the foam layer and does not include a chain extender. Since the non-foam layer is present on the inner surface of a food container, a chain extender does not elute into food even when it comes into contact with food.

The polylactic acid of the non-foam layer may be prepared by the same method as the polylactic acid of the foam layer.

A composition of the non-foam layer may contain 0.3 to 5 parts by weight of a crystallization accelerator with respect to 100 parts by weight of the polylactic acid.

The crystallization accelerator is an additive that improves thermal resistance and durability by increasing the crystallization rate and crystallinity of a foam sheet or molded article during the manufacture of a foam sheet or a heat molding process, and may be stearic acid, hydroxystearic acid or ethylene bis(stearamide).

The content of the crystallization accelerator is preferably 0.3 to 5 parts by weight with respect to 100 parts by weight of the polylactic acid, and when the content of the crystallization accelerator is less than 0.3 parts by weight, sufficient crystallinity may not be achieved, and when the content of the crystallization accelerator is more than 5 parts by weight, the processability of the foam sheet is reduced.

In addition, the foam layer may further include a silane coupling agent. The silane coupling agent may have an organic functional group capable of bonding with an organic compound and a hydrolyzing group capable of reacting with an inorganic material, and may improve an adhesive strength between polylactic acids, and an adhesive strength between the foam layer and the non-foam layer, thereby increasing the adhesion, thermal resistance and durability of the foam sheet.

The content of the silane coupling agent is preferably 1 to 5 parts by weight with respect to 100 parts by weight of the polylactic acid, when the content is less than 1 part by weight, it is difficult to expect an improvement in adhesion, and when the content is more than 10 parts by weight, the interfacial adhesion property and thermal resistance are rather lowered due to the excessive use of the silane coupling agent.

Particularly, both of the epoxy group-containing silane coupling agent and the acrylate group-containing silane coupling agent are used.

The thickness of the non-foam layer is preferably 5 to 50 μm to reduce raw material costs, and may be properly adjusted according to a required characteristic.

Since the non-foam layer does not include a chain extender, a chain extender does not elute into food even when it comes into contact with food.

The non-foam layer is present on one or both surfaces of the foam layer, and when the polylactic acid foam sheet has a bilayer structure, the non-foam layer is necessarily present on the inner surface of a food container to prevent the chain extender from eluting into food.

The multilayer-structured polylactic acid foam sheet can be applied to a high temperature food container such as a disposable cup, tray or packing material as well as a low temperature food container due to excellent thermal resistance, and may be used without deformation even at a high temperature like a microwave.

In addition, in the case of the polylactic acid foam sheet, since the non-form layer is present on the inner surface of a food container, a toxic component such as a chain extender does not elute into food.

In addition, the present invention relates to a method of manufacturing a polylactic acid foam sheet, which includes: forming a foam layer by extruding a composition containing polylactic acid, a foaming agent, a chain extender, a nucleating agent and a crystallization accelerator; and forming a non-foam layer by extruding a composition containing a polylactic acid and a crystallization accelerator on one or both surfaces of the foam layer.

The formation of a non-foam layer is characterized by simultaneously co-extruding a foam layer and a non-foam layer.

The formation of a non-foam layer may be carried out by a method of forming a sheet by extruding a foam layer and then extrusion-coating a non-foam layer thereon, or forming a sheet by extruding a foam layer and then thermal-bonding a non-foam layer. However, these methods have various problems in processes.

According to the thermal bonding method, uniform bonding is possibly made during a process of applying heat only when the thickness of the non-foam layer is 80 to 100 μm. However, due to the large thickness, raw material costs dramatically increase, and due to an additional thermal bonding process, the total number of processes increases and process costs also increase, which is very disadvantageous in terms of production costs.

According to the extrusion coating method, additional process costs are required, it is very difficult to coat a non-foam thin film with a uniform thickness due to a low melt strength of polylactic acid, and the quality of the foam sheet is easily degraded due to the non-uniformity in a coated thickness. In addition, since it is difficult to coat the non-foam layer to a thickness of 80 μm or less due to the feature of a process, a remarkable increase in production costs cannot be avoided.

To solve such a problem, the foam layer and the non-foam layer may be simultaneously co-extruded, and unlike conventional foaming equipment, a precise extrusion die may be used, thereby manufacturing a multilayer-structured polylactic acid foam sheet having a very uniform and thin non-foam layer, which is present on one or both surfaces of the foam layer, in a single process.

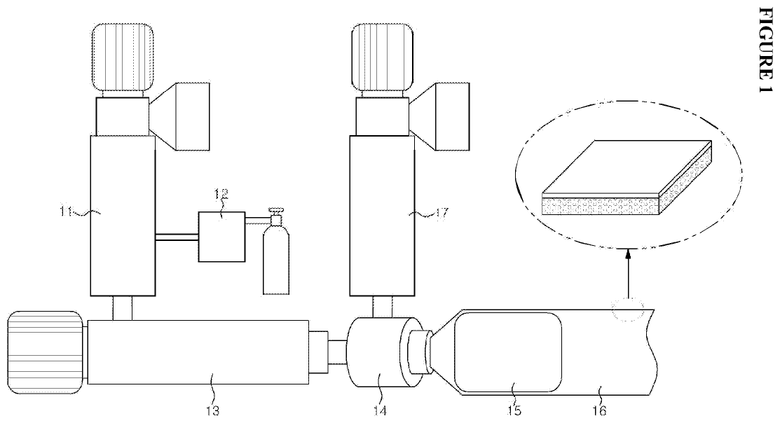

FIG. 1 illustrates an apparatus and method for manufacturing a polylactic acid foam sheet consisting of two layers according to the present invention.

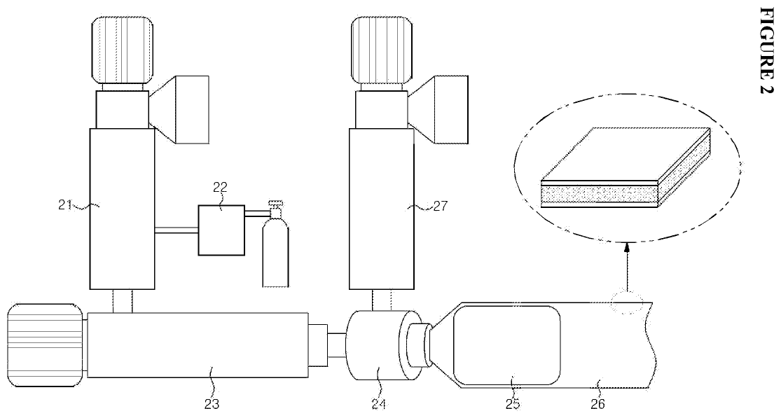

FIG. 2 illustrates an apparatus and method for manufacturing a polylactic acid foam sheet consisting of three layers according to the present invention.

The present invention uses a tandem foaming extruder to manufacture a polylactic acid foam sheet with high foaming magnification.

That is, the tandem foaming extruder includes two extruders connected in series, in which a first extruder 11 or 21 uniformly kneads and thickens the composition, and a second extruder 13 or 23 efficiently cools the composition, and therefore a foam layer composition, which is adjusted in viscosity and melt strength to be suitable for foaming at high magnification, is prepared. A foaming agent pump 12 or 22 is used to inject a foaming agent into a first extruder 11 or 21. Various embodiments for the structure of the tandem foaming extruder will be described below with reference to FIGS. 5 to 9.

Meanwhile, a sub-extruder 17 or 27 is used to form a non-foam layer composition, such that a non-foam layer may be formed to a uniform thickness by uniformly mixing and cooling the composition.

The foam layer composition and the non-foam layer composition may be co-extruded from a co-extrusion die 14 or 24 to coat one or both surfaces of a foam layer with a non-foam layer, and may pass through a mandrel 15 or 25, thereby cooling the foam layer and the non-foam layer as soon as the foam layer is foamed, and therefore, a foam sheet 16 or 26 with excellent thermal resistance and durability may be manufactured.

A circular co-extrusion die may be installed in the tandem foaming extruder, thereby manufacturing a multilayered foam sheet consisting of a 1 to 10-mm polylactic acid foam layer and a 5 to 50-μm polylactic acid non-foam layer present on one or both surfaces thereof in a single process.

Here, the foaming magnification of the polylactic acid foam layer is preferably 5 to 25-fold, and the average foaming magnification of the entire foam sheet including the non-foam layer is preferably 3 to 23-fold. Here, the foaming magnification means a volume ratio after foaming relative to before foaming, based on the same weight of a raw material.

In addition, the present invention relates to an apparatus for producing a multilayered polylactic acid foam sheet, which includes: a foam extruder for manufacturing a foam layer; a sub-extruder for manufacturing a non-foam layer; and a co-extrusion die which co-extrudes the foam layer manufactured by the foam extruder and the non-foam layer manufactured by the sub-extruder.

The structure of the apparatus for producing a multilayered polylactic acid foam sheet is shown in FIG. 1 or 2.

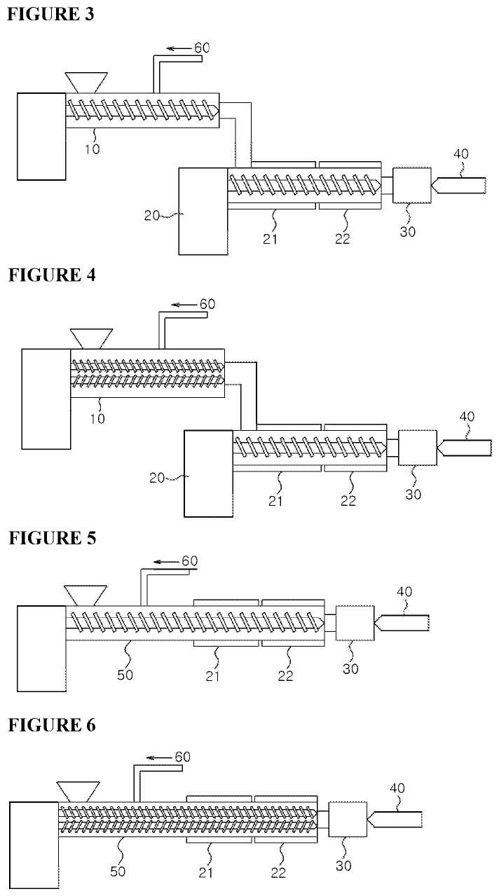

Referring to FIGS. 3 to 7, various embodiments of a foaming extruder for extruding a foam layer among the constituent layers of a foam sheet, which is included in an apparatus for manufacturing a multilayered polylactic acid foam sheet, will be described.

An extruder for manufacturing a foaming plastic with high magnification, for example, 3-fold or more that is generally used, has a barrel cooling system in the rear end of the extruder.

The barrel cooling system may cool a melt in which a foaming gas is dissolved to maximize a melt strength, and thus may help in well forming independent closed cells without bursting a foam cell in instantaneous volume expansion occurring when the melt passes through an extruder die.

In addition, the barrel cooling system may serve to uniformly form an open cell according to use.

However, a conventional extruder uses a water-type barrel cooling system or an oil-type barrel cooling system.

The water-type barrel cooling system is a type for injecting a circulation coil in a jacket normally manufactured by aluminum casting to circulate cooling water, and here, it controls a barrel temperature based on a principle of adjusting the amount of the cooling water injected into the aluminum jacket of each cooling zone, thereby enabling fast and dramatic cooling.

However, although the extruder barrel blocks the additional injection of cooling water at the moment when a desired set temperature is reached, excessive cooling of the barrel may occur due to the absorption of evaporation heat of cooling water previously remaining in the aluminum cooling jacket.

Here, the crystallization or solidification of the melt may occur due to excessive cooling of the barrel, and as the temperature distribution of the melt becomes large, the variation in melt strength of the melt is significantly increased.

As a result, a non-uniform foam cell structure may be obtained, and the loss of the foaming gas becomes very large during the process of bursting the cells, so that a high-magnification product may not be manufactured.

Even in the case of manufacturing porous plastics with open cells rather than independent closed cells, plastics with uniform open cells may be manufactured only when a melt having narrow temperature distribution is obtained, and a foam extruder having the conventional water-type barrel cooling system has technical limits.

In other words, an oil-type barrel cooling system using oil as a refrigerant may inject oil into an aluminum jacket by precisely controlling the oil temperature and circulate the oil, and thus has an advantage of very precise temperature control. However, due to a laminar flow behavior of the oil, its cooling efficiency is lowered, and thus the discharge rate of a foaming plastic decreases and productivity is significantly reduced.

In the present invention, a foam is manufactured using a combined barrel cooling system in which a water-type barrel cooling system and an oil-type barrel cooling system are combined.

That is, in the configuration of the cooling system that is necessarily installed at the rear end of the foaming extruder, a water cooling jacket is installed at the front end of the cooling system to rapidly cool a melt, and an oil cooling jacket is installed at the rear end of the cooling system, thereby very precisely adjusting the temperature of the melt to be ultimately obtained.

As the two types of cooling systems are disposed at suitable positions, advantages for each system may be selectively applied, and a high quality porous plastic product may be manufactured with high productivity.

FIG. 3 illustrates a tandem foam extruder having two single screw extruders connected in series, which is included in an apparatus for manufacturing a polylactic acid foam sheet of the present invention.

FIG. 3 shows a tandem foam extruder in which two single screw extruders are connected in series, which has a combined barrel cooling system (including 21 and 22) installed at a barrel of a second extruder 20, and thus enables rapid cooling and precise temperature control at the same time.

The foam extruder includes a first extruder 10 in which a composition containing a thermoplastic resin and a foaming agent is added, melts and is kneaded; a second extruder 20 in which the melt kneaded in the first extruder is received and cooled; and a die 30 which discharges the melt cooled in the second extruder to the outside of the extruder to foam.

The first extruder 10 serves to knead a molten plastic material with a foaming gas, and feed the kneaded result to the second extruder.

The second extruder 20 receives and cools the melt kneaded in the first extruder.

The present invention uses a combined barrel cooling system in which a water cooler 21 is installed at the front end of the second extruder and an oil cooler 22 is installed at the rear end of the second extruder.

The water cooler 21 may cool a high-temperature melt to near a target temperature within a short time, and the oil cooler 22 may make the temperature of the melt cooled to near a target temperature reach the target temperature to prevent crystallization or solidification caused by overcooling of the melt, maximize the melt strength of the melt by uniformly maintaining the temperature of the melt, make the cell structure of a foam uniform, and improve a foaming rate.

The water cooler 21 may use a method of cooling a barrel by installing an aluminum jacket winding around the barrel, or forming a groove in the surface of the barrel and then winding a cooling water-circulation coil in the groove, and in some cases, and to maximize a cooling effect, the both methods may be used at the same time.

In addition, an electric band heater may be installed in a cooling zone for heating prior to the operation of facilities.

The length of the oil cooler 22 is 5 to 85% of the total length of the cooling system.

The oil cooler 22 may cool a melt by four different methods, for example, by a method of installing an aluminum cast jacket including an oil circulation coil, a method of cooling a barrel by forming a groove in the surface of the barrel and winding an oil circulation coil in the groove, a method of simultaneously using an aluminum cast jacket including an oil circulation coil and an oil circulation coil wound in a groove in the surface of a barrel, or a wet liner method of directly cooling the surface of a barrel by circulating oil in a space between the surface of an uneven barrel and a housing surrounding the barrel.

In addition, the front end of the cooling system is a water cooler, and the middle part of the cooling system may be an oil cooler, and the rear end of the cooling system may be a water cooler.

The melt strength may be maximized by forming the water cooler at the rear end of the cooling system, thereby forming a uniform cell structure of the foam and improving a foaming rate.

By using a combined barrel cooling system, at the front end of the second extruder, a very high-temperature melt may be cooled to near a target temperature within a short time.

In addition, at the rear end of the second extruder, by injecting the circulating oil into an aluminum jacket and a circulation coil after adjusting the oil temperature to the temperature of the melt, the temperature of the melt cooled to near the target temperature may reach the target temperature such that crystallization or solidification caused by over cooling of the melt may be prevented.

That is, since a barrel temperature is constantly maintained at the predetermined target temperature, there is no risk of overcooling of the melt, the temperature of the melt may be uniformly maintained to maximize the melt strength, and the uniform cell structure of the foam may be formed and the foaming rate may be improved.

In addition, a predetermined temperature of the barrel may be reduced to a lower temperature that can maximize melt strength without crystallization or solidification.

The oil cooling area of the second extruder 20 is preferably 5 to 85% of the entire cooling area, and more preferably 20 to 60% thereof. When the oil cooling area has the above-mentioned numerical range, the melt may have uniform temperature distribution and a high melt strength, a uniform foam cell structure, and a maximized foaming rate.

The melt with uniform temperature distribution and high melt strength may form a very uniform cell structure in volume expansion through an extruder die, and may be processed to a porous plastic product having a high foaming magnification of up to 50-fold.

The foam extruder of the present invention may exhibit a very large effect in a high-magnification foaming process of a semi-crystalline polymer such as polyester, polyamide, polyolefin or engineering plastic, which has a narrow process window.

As a foaming agent 60, both of a chemical foaming agent and a physical foaming agent can be used, and the chemical foaming agent may be injected with a plastic raw material through a hopper, and the physical foaming agent may be injected through a barrel of the first extruder.

The present invention may control an independent closed cell rate and a cell structure as desired while maintaining high foaming magnification according to use.

A foam 40 of the present invention may be a sheet, board, bead or profile form.

The independent closed cell rate of the foam 40 may be 70 to 100%, and the foaming rate may be 3 to 50-fold.

In addition, the foam 40 may be an open cell type which has an independent closed cell rate of 0 to 30%, and a foaming rate of 3 to 50-fold.

FIG. 4 illustrates a tandem foam extruder in which a twin-screw extruder and a single-screw extruder are sequentially connected, included in an apparatus for manufacturing a polylactic acid foam sheet of the present invention.

FIG. 4 shows a tandem foam extruder in which a twin screw extruder and a single screw extruder are sequentially connected, and a combined barrel cooling system (including 21 and 22) is installed at the barrel of the second extruder 20 to enable rapid cooling and precise temperature control simultaneously.

The first extruder 10 serves to knead a molten plastic material with a foaming gas and feed the kneaded result to the second extruder.

The second extruder 20 serves to receive and cool the melt kneaded in the first extruder.

Since the first extruder 10 is a twin screw extruder, the kneading degree of the raw material increases, and the dissolution of a foaming gas occurs within a short time.

FIG. 5 illustrates a foam extruder with a single screw, included in an apparatus for manufacturing a polylactic acid foam sheet of the present invention.

FIG. 5 shows a foam extruder 50 with a single screw, and the combined barrel cooling system (including 21 and 22) is installed at the rear end of the extruder 50 to enable both rapid cooling and precise temperature control.

The foam extruder 50 includes a mixer in which a composition containing a thermoplastic resin and a foaming agent is added, melts and is kneaded; a cooling system (including 21 and 22) that receives and cools the melt kneaded in the mixer; and a die 30 that discharges the melt cooled in the cooling system to the outside of the extruder to foam.

Since kneading and cooling of raw materials have to simultaneously occur in one extruder 50, the L/D (L: screw length, D: the inner diameter of a barrel) of the extruder 50 is preferably 30 to 60. When the L/D of the extruder 50 has the above-mentioned numerical range, the melt may have uniform temperature distribution and high melt strength, a uniform foam cell structure and a maximized foaming rate.

The present invention uses a combined barrel cooling system in which a water cooler 21 is installed at the front end of the cooling system and an oil cooler 22 is installed at the rear end of the cooling system.

The water cooler 21 cools a high-temperature melt to near the target temperature within a short time, the oil cooler 22 may make the temperature of the melt cooled to near a target temperature reach the target temperature to prevent crystallization or solidification caused by overcooling of the melt, maximize the melt strength of the melt by uniformly maintaining the temperature of the melt, make the cell structure of a foam uniform, and improve a foaming rate.

The L/D (L: screw length, D: the inner diameter of a barrel) of the foam extruder 50 is 30 to 60.

The length of the cooling system (including 21 and 22) is preferably 20 to 70% of a screw length included in an extruder. When the length of the cooling system (including 21 and 22) is in the above-mentioned numerical range, the melt may have uniform temperature distribution and high melt strength, a uniform cell structure in the manufactured foam, and a maximized foaming rate.

In addition, the oil cooling area of the extruder 50 is preferably 5 to 85%, and more preferably 20 to 60% of the entire cooling area. When the oil cooling area is in the above-mentioned numerical range, the melt may have uniform temperature distribution and high melt strength, the uniform cell structure of a foam, and a maximized foaming rate.

The oil cooler 22 may cool a melt by a method of installing an aluminum cast jacket including an oil circulation coil, a method of cooling a barrel by forming a groove in the surface of a barrel and winding an oil circulation coil in the groove, a method of simultaneously using an aluminum cast jacket including an oil circulation coil and an oil circulation coil wound in a groove in the surface of a barrel, or a wet liner method of directly cooling the surface of a barrel by circulating oil in a space between the surface of the uneven barrel and a housing surrounding the barrel.

The melt having uniform temperature distribution and high melt strength may form a very uniform cell structure in volume expansion through an extruder die 30, and may be processed into a porous plastic product having a high foaming magnification of up to 50-fold.

The foam extruder of the present invention may exhibit a very great effect in a high-magnification foaming process of a semi-crystalline polymer such as a polyester, a polyamide, a polyolefin, or an engineering plastic, which has a narrow process window due to crystallization.

As a foaming agent 60, a chemical foaming agent and a physical foaming agent can be used, and the chemical foaming agent may be injected with a plastic raw material through a hopper, and the physical foaming agent may be injected through a barrel of the extruder.

In the present invention, high foaming magnification may be maintained according to use, and an independent closed cell rate and a cell structure may be controlled as desired.

The foam 40 of the present invention may be a sheet, board, bead or profile form.

The independent closed cell rate of the foam may be 70 to 100%, and the foaming rate may be 3 to 50-fold.

In addition, the foam may be in an open cell foam which has an independent closed cell rate of 0 to 30%, and a foaming rate of 3 to 50-fold.

FIG. 6 illustrates a foam extruder with a twin screw, included in an apparatus for manufacturing a polylactic acid foam sheet of the present invention.

FIG. 6 shows a foam extruder having a twin screw, in which a combined barrel cooling system (including 21 and 22) of the extruder 50 is installed to enable rapid cooling and precise temperature control at the same time.

Since the extruder 50 has a twin screw, it has an advantage that the mixing degree of raw materials increases, and the dissolution of a foaming gas occurs in a short time.

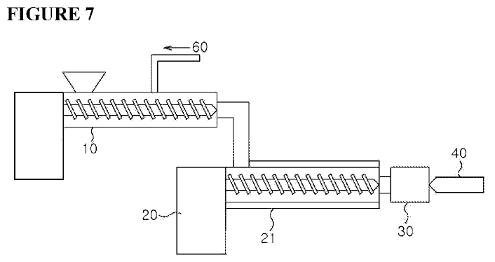

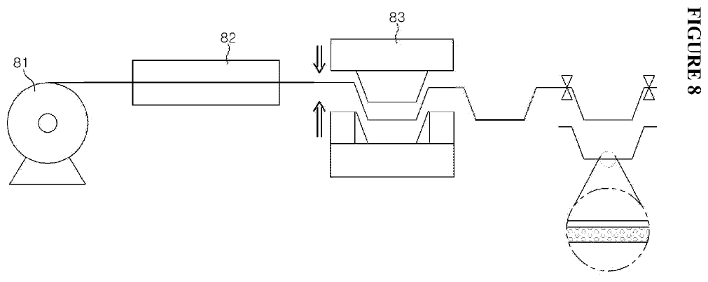

FIG. 7 illustrates a foam extruder with a water cooler installed on the surface of a barrel of a second extruder, included in an apparatus for manufacturing a polylactic acid foam sheet of the present invention.

The foam extruder of FIG. 7 has a water-cooling aluminum jacket 21 installed on the entire region of the barrel of the second extruder 20.

Hereinafter, the present invention will be described in detail with reference to examples and comparative examples. The following examples are merely provided to implement the present invention, and the disclosure of the present invention is not limited by the following examples.

### Example 1

A single-layered foam sheet was manufactured continuously by injecting a semi-crystalline polylactic acid composition and a physical foaming agent into a tandem foam extruder.

The tandem foam extruder may have a structure in which a single screw extruder (first extruder, L/D=32) having a screw diameter of 100 mm and a single screw extruder (second extruder, L/D=32) having a screw diameter of 130 mm are connected in series.

Liquid butane was injected in the middle of the barrel of the first extruder to be kneaded with the molten resin.

A combined barrel cooling system in which a water-cooling aluminum jacket was installed in the front 60% region of the second extruder, and an oil-cooling aluminum jacket was installed in the rear 40% region thereof to precisely control an oil temperature to 140° C. and circulate the oil was used.

With respect to 100 parts by weight of a polylactic acid, one part by weight of a foam nucleating agent, talc, was mixed in a mixer, and then put into the first extruder.

Here, 5 parts by weight of butane was provided to the first extruder and kneaded, and the kneaded melt was fed to the second extruder and cooled, followed by manufacturing a 4-mm-thick foam sheet.

Since crystallization caused by overcooling did not occur in the second extruder, it was possible to perform the operation at a predetermined temperature as low as 140° C., and therefore, a polylactic acid foam sheet having an independent closed cell rate of 85 to 90% and 18-fold foaming magnification was able to be stably manufactured.

The discharge amount per time of the foam sheet was as high as 350 kg, and the polylactic acid foam sheet may be used as a meat tray or various forms of food packing containers after going through an additional thermoforming process.

### Example 2

A single-layered foam sheet was continuously manufactured by inputting a polypropylene resin composition having a high melt strength and a chemical foaming agent, azodicarbonamide, to a long single screw extruder.

The single screw foam extruder has a screw diameter of 100 mm and a L/D of 54, and a combined cooling system was used to perform the input, melting and kneading of a raw material occurring in the front end of the extruder (27D length) and the cooling of the melt occurring in the rear end (27D length).

A water-cooling aluminum jacket was installed in the front 14D-length region of the cooling system, and a wet liner-type oil cooler was installed in the rear 13D-length region thereof so that an oil temperature was precisely controlled to 155° C. and the oil was circulated directly in contact with a barrel surface.

0.7 parts by weight of a foam nucleating agent, talc, and 3 parts by weight of a chemical foaming agent, azodicarbonamide, were input through a hopper with respect to 100 parts by weight of a polypropylene resin and kneaded, and then the kneaded melt was fed to the cooling system and cooled, thereby manufacturing a 3-mm-thick foam sheet.

Since crystallization caused by overcooling did not occur in the rear end of the extruder, the extruder was able to be operated at a predetermined temperature, which is as low as 155° C., and therefore a foam sheet having an independent closed cell rate of 70 to 80% and 5-fold foaming magnification was able to be stably manufactured.

The discharge amount per time of the foam sheet was as high as 300 kg, and a polypropylene foam sheet may be used as a meat tray or various forms of food packing containers after going through an additional thermoforming process.

### Example 3

A single-layered foam sheet was manufactured continuously by injecting a semi-crystalline polylactic acid composition and a physical foaming agent into a tandem foam extruder.

The tandem foam extruder may have a structure in which a single screw extruder (first extruder, L/D=32) having a screw diameter of 100 mm and a single screw extruder (second extruder, L/D=32) having a screw diameter of 130 mm are connected in series.

Carbon dioxide was injected in the middle of the barrel of the first extruder to be kneaded with the molten resin.

A combined barrel cooling system in which a water-cooling aluminum jacket was installed in the front 55% region of the second extruder, and an oil-cooling aluminum jacket was installed in the rear 45% region thereof to precisely control an oil temperature to 140° C. and circulate the oil was used.

With respect to 100 parts by weight of a polylactic acid, one part by weight of a foam nucleating agent, talc, was mixed in a mixer, and 20 parts by weight of an open cell-forming additive was mixed in a mixer, and then put into the first extruder.

Here, 8 parts by weight of carbon dioxide was provided to the first extruder and kneaded, and the kneaded melt was fed to the second extruder and cooled, followed by manufacturing an open cell foam sheet having a thickness of 5 mm.

Since crystallization caused by overcooling did not occur in the second extruder, the extruder was able to be operated at a predetermined temperature, which is as low as 140° C., and therefore, a polylactic acid foam sheet having an independent closed cell rate of 85 to 90% and 20-fold foaming magnification was able to be stably manufactured.

The discharge amount per time of the foam sheet was as high as 330 kg, and the polylactic acid open-cell foam sheet may be used as a scaffold material, which is an artificial biomaterial for medical use.

### Comparative Example 1

A polylactic acid foam sheet was manufactured by the same method as described in Example 1, except that a water-cooling aluminum jacket was installed in the entire region of a barrel of a second extruder (FIG. 7).

The foam sheet exhibited a 55% independent closed cell rate and 3-fold foaming magnification due to crystallization caused by overcooling in the second extruder.

In addition, the present invention relates to a polylactic acid foam-molded article manufactured by removing a foaming agent contained in a foam sheet by aging the multilayered polylactic acid foam sheet for 3 to 10 days; softening the aged foam sheet by being heated to 100 to 250° C.; and forming the softened foam sheet with a mold.

FIG. 8 illustrates a method of manufacturing a polylactic acid molded article according to the present invention.

The manufactured multilayer-structured polylactic acid foam sheet was wound in a roll form, and went through 3 to 10-day room temperature aging process to remove some of a foaming agent remaining in the foam layer. That is, the foam sheet had to be aged through a degassing step for a certain time. This is performed to solve an excessive pre-expansion problem in a thermoforming step.

The aged foam sheet 81 was completed into various forms of food containers or industrial packing material molded articles through a thermoforming step. The first step of thermoforming is softening, and the foam sheet was softened to be molded through an oven 82 like a long tunnel.

Here, the temperature of the heating oven 82 is preferably 100 to 250° C., and the softened foam sheet immediately enters a subsequent mold press unit 83 and thus is changed into various forms such as a food container, tray and packing material.

The multilayered polylactic acid foam sheet has to be heated to increase the crystallinity of the polylactic acid article while being compressed between the upper part and the lower part of the mold. Here, the temperature of the mold is preferably 50 to 130° C., and the heating time by the mold is properly 3 to 15 seconds. The polylactic acid foam-molded article manufactured by a heat crystallization molding method as described above has excellent thermal resistance, and durability without deformation even when it contains boiling water or is heated in a microwave.

That is, as the crystallinity of the polylactic acid foam sheet increases by the thermoforming process, the thermal resistance of the foam-molded article is improved, and here, the crystallinity of the foam-molded article is preferably 10% or more, and more preferably, 20% or more.

The manufactured polylactic acid foam-molded article has a heat deflection temperature of 100 to 150° C., and thus may have no problem in use as an instant noodle container, a processed food packing tray or a coffee cup which contains boiling water, have no deformation of a container even when used as a lunch box tray that heats food by putting it in a microwave, and fundamentally exclude the elution risk of a chain extender which has toxicity.

In addition, the polylactic acid foam-molded article includes a foam layer so that there is heat insulation, and therefore, it is easy to hold with bare hands, and excellent heat insulation of the contained food.

In addition, the present invention relates to a thermally-resistant food container and packing material, which are manufactured by thermal molding of the multilayered polylactic acid foam sheet.

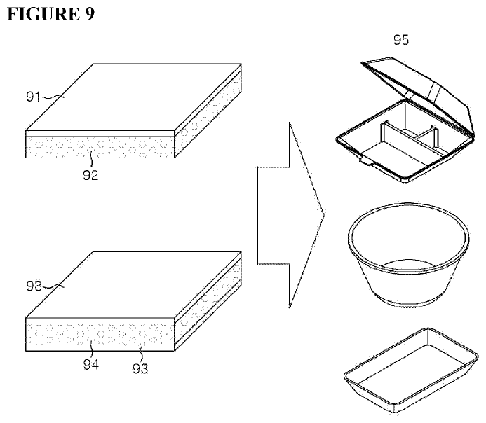

FIG. 9 illustrates a polylactic acid molded article manufactured by heat-molding a polylactic acid foam sheet of the present invention.

A multilayer-structured polylactic acid foam sheet including a foam layer 92 or 94 and one or more non-foam layers 91 and 93 may be used in a final molded article 95. The multilayer-structured polylactic acid foam sheet can be applied in high-temperature food containers such as disposable cups, trays and packing materials as well as low-temperature food containers, and may be used without deformation under a high temperature condition such as a microwave.

In addition, in the case of the polylactic acid foam sheet, since the non-foam layer 91 or 93 is present on the inner surface of a food container, a toxic component such as a chain extender does not elute into food so that human safety is high.

Hereinafter, the present invention will be described in detail through Examples and Comparative Examples. The following Examples are only exemplified for the practice of the present invention, and the contents of the present invention are not limited by the following Examples.

### Example 4

A polylactic acid foam layer was manufactured by polymerizing 3 mol % of D-lactide and 97 mol % of L-lactide.

A foam layer composition was prepared by injecting 100 parts by weight of the polylactic acid, 6 parts by weight of butane, 0.5 parts by weight of a copolymer of glycidyl methacrylate and styrene, 1 part by weight of talc and 1 part by weight of stearic acid into a tandem foam extruder.

The tandem foam extruder has a structure in which a first extruder 11 having a screw diameter of 100 mm and a second extruder 13 having a screw diameter of 130 mm are sequentially connected, and a gas inlet is formed to enable injection of butane in the middle of the first extruder 11.

A polylactic acid non-foam layer was manufactured by polymerizing 3 mol % of D-lactide and 97 mol % of L-lactide.

A non-foam layer composition was prepared by injecting 100 parts by weight of the polylactic acid and 1 part by weight of stearic acid into a sub-extruder 17.

The foam layer composition and the non-foam layer composition were co-extruded from a circular co-extrusion die 14, 24 to coat one or both surfaces of a foam layer with a non-foam layer, and passed through a mandrel 15, thereby cooling the foam layer and the non-foam layer as soon as the foam layer is foamed, and therefore, a foam sheet 16 with excellent thermal resistance and durability was manufactured.

Here, the thickness of the foam layer was 3 mm, and the thickness of the non-foam layer was 20 μm.

After the foam sheet was aged at room temperature for 5 days, it was heated in a 250° C. heating oven, softened, and heat-formed with a mold, thereby manufacturing a foam-molded article. Here, the temperature of the mold was 100° C., and the foam sheet was heated in the mold for 15 seconds.

### Example 5

A polylactic acid foam-molded article was manufactured by the same method as described in Example 4, except that a stereocomplex polylactic acid was prepared by blending 40 wt % of poly-D-lactic acid and 60 wt % of poly-L-lactic acid and used for a foam layer and a non-foam layer.

### Example 6

A polylactic acid foam-molded article was manufactured by the same method as described in Example 4, except that a non-foam layer was co-extruded on both surfaces of a foam layer to a thickness of 20 μm to manufacture a foam sheet.

### Example 7

A polylactic acid foam-molded article was manufactured by the same method as described in Example 5, except that a non-foam layer was co-extruded on both surfaces of a foam layer to a thickness of 20 μm to manufacture a foam sheet.

### Example 8

A polylactic acid foam-molded article was manufactured by the same method as described in Example 4, except that 0.5 parts by weight of a copolymer of glycidyl methacrylate and 3-methacryloxypropylmethyldimethoxysilane was additionally used.

### Example 9

A polylactic acid foam-molded article was manufactured by the same method as described in Example 4, except that 0.2 parts by weight of a copolymer of glycidyl methacrylate and styrene was used.

### Example 10

A polylactic acid foam-molded article was manufactured by the same method as described in Example 4, except that 4 parts by weight of a copolymer of glycidyl methacrylate and styrene was used.

### Comparative Example 2

A polylactic acid foam-molded article was manufactured by the same method as described in Example 4, except that the temperature of a mold was set to 40° C. in a thermoforming step.

### Comparative Example 3

A polylactic acid foam-molded article was manufactured by the same method as described in Example 4, except that the temperature of a mold was set to 150° C. in a thermoforming step and heating was performed for 3 seconds.

### Comparative Example 4

A polylactic acid foam-molded article was manufactured by the same method as described in Example 4, except that bisphenol A diglycidylether was used instead of a copolymer of glycidyl methacrylate and styrene.

The properties of the polylactic acid foam-molded articles manufactured in Examples 4 to 10 and Comparative Examples 2 to 4 were measured, and the results are shown in Table 1 below.

The heat deflection temperature of the polylactic acid foam sheet molded article was measured according to ASTM D 648.

In addition, a specimen having a size of 20 cm (width)×20 cm (length) was obtained from the bottom of the thermoformed molded article and put into a hot air dryer to be thermally treated at 100° C. for 20 minutes, and the shrinkage rate and surface condition of the specimen was observed, followed by measuring the thermal resistance of the polylactic acid foam-molded article.

⊚: No change in shrinkage and surface condition

∘: Shrinkage rate of less than 3%, and no change in surface condition

Δ: Shrinkage rate of 3 to 10%, and surface deformation

x: Shrinkage rate of more than 10%, and severe surface deformation

TABLE 1

| | | | | | | | | Comparative | | |
|---|---|---|---|---|---|---|---|---|---|---|
| | Example | | | | | | | Example | | |
| Classification | 4 | 5 | 6 | 7 | 8 | 9 | 10 | 2 | 3 | 4 |
| Heat deflection | 110 | 128 | 113 | 132 | 122 | 101 | 102 | 47 | 49 | 53 |
| temperature | | | | | | | | | | |
| (° C.) | | | | | | | | | | |
| Thermal | ⊚ | ⊚ | ⊚ | ⊚ | ⊚ | ◯ | ◯ | X | X | Δ |
| resistance | | | | | | | | | | |

From the result of Table 1, the polylactic acid foam-molded articles of Examples 4 to 10 may be widely used in high temperature food containers such as cups, trays and packing materials due to an excellent heat deflection temperature, excellent thermal resistance and excellent durability.

Meanwhile, it can be seen that the heat deflection temperature, thermal resistance and durability of the polylactic acid foam-molded articles of Comparative Examples 2 to 4 are inferior to those of Examples.

As described above, although the present invention has been described by limited examples and drawings, the present invention is not limited to the examples, and various modifications and alterations are possible from these descriptions by those of ordinary skill in the art to which the present invention belongs.

### INDUSTRIAL APPLICABILITY

The present invention may provide a polylactic acid foam sheet having an excellent heat deflection temperature, excellent thermal resistance, excellent durability, excellent human safety and excellent biodegradability by co-extruding a foam layer and a non-foam layer.

In addition, the present invention may provide an apparatus for manufacturing a polylactic acid foam sheet including a foam extruder, which may maximize the melt strength of a melt by uniformly maintaining the temperature of the melt without crystallization or solidification caused by overcooling of a melt, make a cell structure of a foam uniform and improve a foaming rate.

In addition, the present invention may provide an apparatus for manufacturing a polylactic acid foam sheet including a foam extruder, which may produce a high-quality foam at a high discharge speed by using a combined barrel cooling system in which a water cooler and an oil cooler are connected.

In addition, the present invention may provide a polylactic acid foam sheet including a foam with high foaming magnification through a continuous extrusion process of plastic materials that are difficult to foam using a conventional extruder.

In addition, the present invention may provide a high-quality polylactic acid foam sheet since the crystallization or solidification of a melt caused by overcooling may be prevented even in the case of a semi-crystalline polymer with a narrow process window.

In addition, the present invention may provide a polylactic acid foam-molded article which can be widely used in a high temperature food container and a low temperature food container due to an excellent heat deflection temperature, excellent thermal resistance, excellent durability and excellent biodegradability.

In addition, the present invention may provide a polylactic acid foam-molded article with very high economic feasibility since the thickness of a non-foam layer can be remarkably reduced by using a co-extrusion method.

In addition, the present invention may provide a food container with excellent thermal resistance, durability, biodegradability, and human safety, in which a chain extender does not elute into food due to a non-foam layer present on the inner surface of a food container.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A multilayered polylactic acid foam sheet, comprising:
a foam layer manufactured by extruding a composition comprising a polylactic acid, a foaming agent, a chain extender, a nucleating agent and a crystallization accelerator; and
a non-foam layer formed on one or both surfaces of the foam layer, and manufactured by extruding a composition comprising a polylactic acid and a crystallization accelerator, and which is manufactured by co-extruding the foam layer and the non-foam layer in a single process,
wherein the polylactic acid of the foam layer and the non-foam layer is prepared by polymerization of 0.1 to 5 mol % of D-lactide and 95 to 99.9 mol % of L-lactide, or a stereocomplex polylactic acid is prepared by blending 10 to 60 wt % of poly-D-lactic acid and 40 to 90 wt % of poly-L-lactic acid,
wherein the chain extender is a copolymer of glycidyl methacrylate and styrene; or a copolymer of glycidyl acrylate and styrene, and
wherein the composition of the foam layer comprises 1 to 10 parts by weight of the foaming agent, 0.3 to 1.5 parts by weight of the chain extender, 0.2 to 5 parts by weight of the nucleating agent and 0.3 to 5 parts by weight of the crystallization accelerator with respect to 100 parts by weight of the polylactic acid.

2. The foam sheet of claim 1, wherein the co-extruded foam layer has a foaming magnification of 5 to 25-fold.

3. The foam sheet of claim 1, wherein the co-extruded non-foam layer has a thickness of 5 to 50 μm.

4. A polylactic acid foam-molded article manufactured using the multilayered polylactic acid foam sheet of claim 1 by a method comprising:
removing a foaming agent contained in a foam sheet by aging the multilayered polylactic acid foam sheet of claim 1 for 3 to 10 days;
softening the aged foam sheet by heating the aged foam sheet to 100 to 250° C.; and
forming the softened foam sheet with a mold,
wherein the temperature of the mold is 50 to 130° C.,
wherein the time taken to heat the foam sheet in the mold is 3 to 15 seconds, and
wherein the foam-molded article has a crystallinity of 10% or more.

5. An apparatus for producing the multilayered polylactic acid foam sheet of claim 1, comprising:
a foam extruder for manufacturing the foam layer;
a sub-extruder for manufacturing the non-foam layer; and
a co-extrusion die which co-extrudes the foam layer manufactured by the foam extruder and the non-foam layer manufactured by the sub-extruder,
wherein the foam extruder comprises:
a first extruder in which a composition containing a thermoplastic resin and a foaming agent is added, melts and is kneaded;
a second extruder in which the melt kneaded in the first extruder is received and cooled; and
a die which discharges and foams the melt cooled in the second extruder to the outside of the extruder,
wherein a cooling system which cools the melt is installed on the surface of a barrel of the second extruder,
wherein the front end of the cooling system is a water cooler, and the rear end of the cooling system is an oil cooler,
wherein the water cooler cools a high temperature melt to near a target temperature within a short time,
wherein the oil cooler makes the melt cooled to near the target temperature reach the target temperature so as to prevent crystallization or solidification caused by overcooling of the melt, uniformly maintain the temperature of the melt, maximize the melt strength of the melt, makes the cell structure of a foam uniform, and improve a foaming rate,
wherein the cooling system lowers the target temperature of the melt to a temperature that maximizes the melt strength without crystallization or solidification, and
wherein the length of the oil cooler is 5 to 85% of the total length of the cooling system.

6. The apparatus of claim 5, wherein the oil cooler cools the melt by a method of installing an aluminum cast jacket including an oil circulation coil, a method of cooling a barrel by forming a groove in the surface of the barrel and winding an oil circulation coil in the groove, a method of simultaneously using an aluminum cast jacket including an oil circulation coil and an oil circulation coil wound in a groove in the surface of a barrel, or a wet liner method of directly cooling the surface of a barrel by circulating oil in a space between the surface of the uneven barrel and a housing surrounding the barrel.

7. An apparatus for producing the multilayered polylactic acid foam sheet of claim 1, comprising:
a foam extruder for manufacturing the foam layer;
a sub-extruder for manufacturing the non-foam layer; and
a co-extrusion die which co-extrudes the foam layer manufactured by the foam extruder and the non-foam layer manufactured by the sub-extruder,
wherein the foam extruder comprises:
a mixer in which a composition containing a thermoplastic resin and a foaming agent is added, melts and is kneaded;
a cooling system in which the melt kneaded in the mixer is received and cooled; and
a die which discharges the melt cooled in the cooling system to the outside of the extruder to foam,
wherein a cooling means which cools the melt is installed on the surface of the cooling system,
wherein the front end of the cooling system is a water cooler, and the rear end of the cooling system is an oil cooler,
wherein the water cooler cools a high-temperature melt to near a target temperature within a short time,
wherein the oil cooler makes the temperature of the melt cooled to near a target temperature reach the target temperature to prevent crystallization or solidification caused by overcooling of the melt, maximize the melt strength of the melt by uniformly maintaining the temperature of the melt, make the cell structure of a foam uniform, and improve a foaming rate,
wherein the cooling system lowers the target temperature of the melt to a temperature that maximizes the melt strength without crystallization or solidification, and
wherein the length of the oil cooler is 5 to 85% of the total length of the cooling system.

8. The apparatus of claim 7, wherein the foam extruder has a L/D (L: screw length, D: the inner diameter of a barrel) of 30 to 60.

9. The apparatus of claim 7, wherein the length of the cooling system is 20 to 70% of the screw length in the extruder.

10. The apparatus of claim 7, wherein the oil cooler cools the melt by a method of installing an aluminum cast jacket including an oil circulation coil, a method of cooling a barrel by forming a groove in the surface of the barrel and winding an oil circulation coil in the groove, a method of simultaneously using an aluminum cast jacket including an oil circulation coil and an oil circulation coil wound in a groove in the surface of a barrel, or a wet liner method of directly cooling the surface of a barrel by circulating oil in a space between the surface of the uneven barrel and a housing surrounding the barrel.
